(19) United States
(12) Patent Application Publication
(10) Pub. No.: US 2006/0066889 A1
(43) Pub. Date: Mar. 30, 2006

(54) Image forming apparatus with improved convenience of Internet facsimile and program product causing computer controlling the image forming apparatus to execute print notifying function

(75) Inventors: Tatsuro Asano, Toyokawa-shi (JP); Hiroyasu Ito, Okazaki-shi (JP); Hiroaki Sugimoto, Nagoya-shi (JP); Tomoyuki Atsumi, Toyohashi-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Tokyo (JP)

(21) Appl. No.: 11/016,955

(22) Filed: Dec. 21, 2004

(30) Foreign Application Priority Data
Sep. 28, 2004 (JP) 2004-282007

(51) Int. Cl. G06F 3/12

(52) U.S. Cl. 358/1.15

(57) ABSTRACT

Data type of data attached to a first e-mail received by using an account data is determined, and if the attached data is an image data of a prescribed format, the image data is printed, and a second e-mail notifying completion of printing is transmitted to the destination of the first e-mail.

This application is based on Japanese Patent Application No. 2004-282007 filed with the Japan Patent Office on Sep. 28, 2004, the entire content of which is hereby incorporated by reference.

### BACKGROUND OF THE INVENTION

1. Field of the Invention

The present invention relates to an image forming apparatus and a program product causing a computer controlling the image forming apparatus to execute a print notifying function. Specifically, the present invention relates to an image forming apparatus printing image data attached to an electronic mail (e-mail), and to a program product causing a computer controlling the image forming apparatus to execute a print notifying function.

2. Description of the Related Art

Conventionally, facsimile data transmission/reception has been dominantly through a telephone network. Recently, however, Internet facsimile, in which facsimile data is transmitted/received through a network such as the Internet has come to be used increasingly.

Internet facsimile employs various methods, one of which uses an e-mail having image data of a prescribed format attached (hereinafter also referred to as image-attached e-mail) for transmission/reception. In the following, the data of image-attached e-mail used for Internet facsimile will also be referred to as Internet facsimile data. Further, the image data contained in the Internet facsimile data will also be referred to as Internet facsimile image data.

The Internet facsimile data can be transmitted to/received from a common personal computer (hereinafter also denoted by “PC”), as well as to/from a multi functional peripheral (hereinafter also denoted by “MFP”) having the functions of a printer, facsimile, scanner and the like.

In connection with the Internet facsimile technique, Japanese Laid-Open Patent Publication No. 2001-119518 discloses a technique of notifying reception of the Internet facsimile data to a network-connected PC.

Further, in connection with the Internet facsimile technique, Japanese Laid-Open Patent Publication No. 2003-125149 discloses a technique of reducing load on a mail server.

In the technique disclosed in Japanese Laid-Open Patent Publication No. 2003-125149, however, it is necessary to allocate a dedicated e-mail address to the MFP (hereinafter also referred to as MFP dedicated address). Therefore, a transmitter of an Internet facsimile data must separately use the e-mail address allocated to the PC as a destination and the e-mail address allocated to the MFP (MFP dedicated address) connected to the PC. This is troublesome and inconvenient.

Further, it is necessary for the receiver of the Internet facsimile data to set the MFP dedicated address to the MFP, which setting is also troublesome and inconvenient.

By the conventional Internet facsimile technique, among a plurality of MFPs connected to a network, if an MFP that received the Internet facsimile data should fail to provide a print-out due to some malfunction or trouble, other normally operating MFPs could not be utilized, and the print-out would not be obtained until the trouble of the MFP is solved.

### SUMMARY OF THE INVENTION

An object of the present invention is to provide an image forming apparatus that improves convenience of Internet facsimile.

Another object of the present invention is to provide a program product that causes a computer controlling the image forming apparatus with improved convenience of Internet facsimile to execute a print notifying function.

A further object of the present invention is to provide an image forming apparatus that can more reliably print the image data received through Internet facsimile.

According to an aspect, the present invention provides an image forming apparatus, including: a storage unit storing an account data related to a prescribed destination; a communication unit transmitting/receiving an e-mail; a control unit determining whether data attached to the e-mail is an image data of a prescribed format or not; and a printer unit printing an image in accordance with the image data; wherein the communication unit receives a first e-mail corresponding to the destination utilizing the account data; and the control unit determines whether data attached to the first e-mail is an image data of a prescribed format or not and if the attached data is image data of the prescribed format, controls the printer unit such that the image in accordance with the image data is printed, and controls the communication unit such that a second e-mail notifying completion of printing is transmitted to the destination of the first e-mail.

Preferably, the control unit determines whether the printer unit can print the image in accordance with the image data or not, and if it is determined that printing is impossible, controls the communication unit such that the first e-mail is transferred to another image forming apparatus.

Preferably, the communication unit receives from the said another image forming apparatus a print complete notice notifying that the image has been printed in accordance with the data attached to the transferred first e-mail. When the communication unit receives the print complete notice from the said another image forming apparatus, the control unit controls the communication unit such that a third e-mail containing information specifying the said another image forming apparatus and notifying the completion of printing is transmitted to the destination of the first e-mail.

Preferably, the control unit determines whether an image could be printed based on the image data by the said another image forming apparatus or not, and if it is determined that the printing failed, controls the communication unit such that the first e-mail is transferred to an image forming apparatus different from the said another image forming apparatus.

According to another aspect, the present invention provides a program product causing a computer controlling an image forming apparatus, which has a storage unit storing account data related to a prescribed destination and a printer unit for printing data, to execute a print notifying function. The program product causes the computer to execute the steps of: receiving a first e-mail corresponding to the destination, utilizing the account data; determining whether the data attached to the first e-mail is image data of a prescribed format or not; if the attached data is image data of the prescribed format, controlling the printer unit such that an image based on the image data is printed; and transmitting a second e-mail notifying completion of printing to the destination of the first e-mail.

Preferably, the program product causes the computer to execute the steps of determining whether the printer unit is capable of printing the image based on the image data; and if it is determined that the printer unit is not capable of printing said image, transferring the first e-mail to another image forming apparatus.

Preferably, the program product causes the computer to execute the steps of: receiving from the said another image forming apparatus a print complete notice notifying that the image has been printed based on the data attached to the transferred first e-mail; and when the print complete notice is received from the said another image forming apparatus, transmitting a third e-mail containing information specifying the said another image forming apparatus and notifying the completion of printing to the destination of the first e-mail.

Preferably, the program product causes the computer to execute the steps of: determining whether the said another image forming apparatus could print the image based on the image data; and if it is determined that the said another image forming apparatus could not print the image, transferring the first e-mail to an image forming apparatus different from the said another image forming apparatus.

Therefore, according to the present invention, it becomes possible to use Internet facsimile that transmits/receives e-mail having a prescribed image data attached thereto, without the necessity of allocating a dedicated mail address to the image forming apparatus.

Further, as the plurality of image forming apparatuses are used, the image data received through Internet facsimile can more reliably be printed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows a network system that can utilize Internet facsimile, in accordance with a first embodiment of the present invention.

FIG. 2 is a block diagram representing an MFP configuration.

FIG. 3 is a flow chart representing a process executed by the MFP.

FIG. 4 shows an example of a print-out complete notice.

FIG. 5 is a flow chart representing a process executed by the MFP.

FIG. 6 shows an example of a print-out incomplete notice.

FIG. 7 shows an example of a mail notifying file format abnormality.

### DESCRIPTION OF THE PREFERRED EMBODIMENTS

Embodiments of the present invention will be described in the following with reference to the figures. In the following description, same or corresponding portions are denoted by the same reference characters, and names and functions thereof are also the same. Therefore, detailed description thereof will not be repeated.

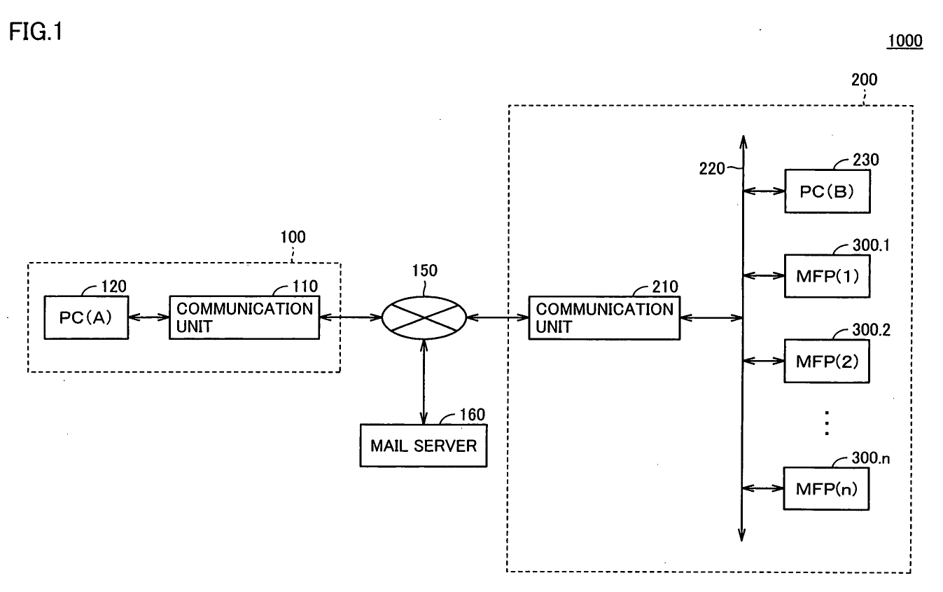

Referring to FIG. 1, a network system 1000 includes a network 100, an external network 150 such as the Internet, a mail server 160 and a network 200.

Network 100 is the network on the Internet facsimile transmitting side. Network 100 includes a PC 120 and a communication unit 110.

Communication unit 110 communicates data with PC 120. Further, communication unit 110 performs wired or wireless data communication with network 150. Communication unit 110 is a communication interface (such as a router) utilizing Ethernet (Registered Trademark).

Further, communication unit 110 may be any communication interface that performs data communication utilizing wired or wireless LAN technique, such as IEEE 802.11a, IEEE802.11b or IEEE802.11g as a wireless LAN standard.

Network 150 is connected to a mail server 160.

Mail server 160 temporarily stores e-mail data or Internet facsimile data to network 100 or network 200.

Network 200 is the network on the Internet facsimile receiving side. Network 200 includes a communication unit 210, a network circuit 220, a PC 230, and MFPs 300.1, 300.2, . . . 300.n.

Communication unit 210 communicates data with network 150. Further, communication unit 210 performs wired or wireless data communication with network 150 or with network circuit 220. Communication unit 210 is a communication interface (such as a router) utilizing Ethernet (Registered Trademark).

Further, communication unit 210 may be any communication interface that performs data communication utilizing wired or wireless LAN technique, such as IEEE 802.11a, IEEE802.11b or IEEE802.11g as a wireless LAN standard.

PC 230 performs wired or wireless data communication with network circuit 220. A unique IP address is allotted to PC 230.

Each of MFPs 300.1, 300.2, . . . 300.n perform wired or wireless data communication with network circuit 220. A unique IP address is allotted to each of MFPs 300.1, 300.2, . . . 300.n. In the following, MFPs 300.1, 300.2, . . . 300.n will be generally denoted by MFP 300.

Network system 1000 of the present embodiment is not limited to the configuration shown in FIG. 1. By way of example, mail server 160 may be provided inside network 100 and network 200.

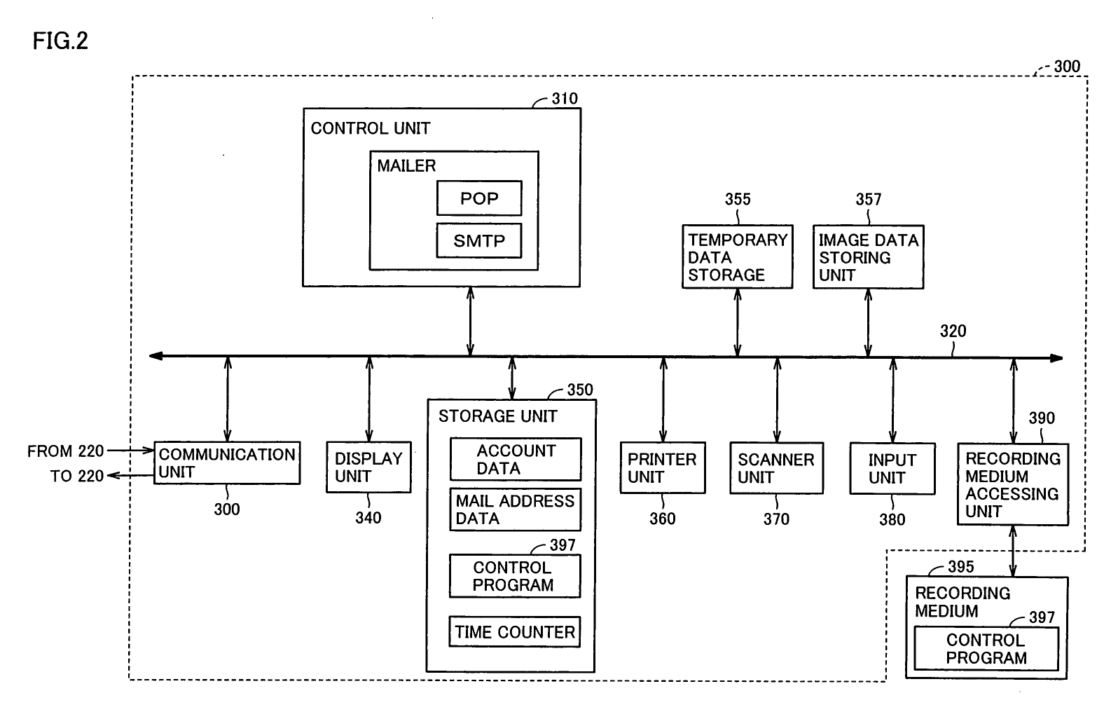

Referring to FIG. 2, MFP 300 includes a control unit 310, a bus 320, a communication unit 330, a display unit 340, a storage unit 350, a temporary data storage 355, an image data storage unit 357, a printer unit 360, a scanner unit 370, an input unit 380 and a recording medium accessing unit 390.

Control unit 3 10 has functions of controlling various units in MFP 300 and performing operations. Control unit 310 is connected to bus 320 that allows data exchange.

Control unit 310 may be a microprocessor, an FPGA (Field Programmable Gate Array) that is a programmable LSI (Large Scale Integration), an ASIC (Application Specific Integrated Circuit) that is an integrated circuit designed and manufactured for a specific application, or any other circuit having an operating function.

Bus 320 is connected to communication unit 330, display unit 340, storage unit 350, temporary data storage 355, image data storage unit 357, printer unit 360, scanner unit 370, input unit 380 and recording medium accessing unit 390 and performs data communication with each of the connected units.

Communication unit 330 performs wired or wireless data communication with network circuit 220. Communication unit 330 has a modem function of transmitting an e-mail having image data read by scanner unit 370 attached thereto, as will be described later, to network circuit 220 and receiving Internet facsimile data from network circuit 220. Communication circuit 330 is a communication interface utilizing Ethernet (Registered Trademark).

Further, communication unit 330 is an interface similar to communication unit 210 described above.

Storage unit 350 stores a time counter for time management, account data, mail address data, control program 397 causing control portion 310 to perform a prescribed process, and so on.

The account data includes data (log-in name, password and the like) for receiving a mail address allocated to PC 230. The mail address data is the data of mail address allocated to PC 230.

Storage unit 350 is a hard disk that can store a large amount of data. Storage unit 350 is not limited to a hard disk, and it may be any medium that can retain data (such as a flash memory) in a non-volatile manner even when power is not supplied.

Specifically, storage unit 350 may be an EPROM (Erasable Programmable Read Only Memory) that allows unlimited number of erasure and writing, an EEPROM (Electrically Erasable and Programmable Read Only Memory) of which contents can be electrically rewritten, an UV-EPROM (Ultra-Violet Erasable Programmable Read Only Memory) allowing unlimited number of erasure and writing by ultra-violet ray, or any other circuit that has a structure allowing storage and retention of data in a non-volatile manner.

Temporary data storage 355 is used as a work memory that is data-accesses by control unit 310 through bus 320 for temporarily storing data. Temporary data storage 355 temporarily stores data of the e-mail received by MFP 300. Further, temporary data storage 355 temporarily stores Internet facsimile data.

Temporary data storage 355 may be an RAM (Random Access Memory) that can temporarily store data, an SRAM (Static Random Access Memory), a DRAM (Dynamic Random Access Memory), an SDRAM (Synchronous DRAM), a DDR-SDRAM (Double Data Rate SDRAM) that is an SDRAM having a high data transfer function of double data rate mode, an RDRAM (Rambus Dynamic Random Access Memory) that is a DRAM adopting a high speed interface technique developed by Rambus Inc., a Direct-RDRAM (Direct Rambus Dynamic Random Access Memory), or any other circuit that has a structure allowing storage and retention of data in a volatile manner.

Printer unit 360 prints characters or an image on a prescribed sheet of paper and outputs the printed sheet of paper. In the following, the operation of outputting the printed sheet of paper will also be referred to as a print-out.

Scanner unit 370 has a function of reading an original by a CCD (charge coupled device) sensor or the like (not shown), and outputting the result as image data.

Image data storage unit 357 stores, by the processing of control unit 310, the image data decoded by control unit 310, image data read by scanner unit 370 and the like.

Image data storage unit 357 is similar to temporary data storage 355 described above.

Display unit 340 displays, by way of example, state of operation of MFP 300, an image based on the image data output from scanner unit 370, and state of printing by printer unit 360.

Display unit 340 may be a liquid crystal display (LCD), a field emission display (FED), organic electro luminescence (EL) display, a dot matrix display, or a display device of any other type.

Input unit 380 is provided with various keys (start key, ten keys, function key) for operating MFP 300. It is possible for a user to input account data and mail address data using input unit 380. The account data and mail address data input through input unit 380 are stored by control unit 310 in storage unit 350.

Recording medium accessing unit 390 has a function of reading control program 397 from recording medium 395 having control program 397 and the like stored therein. Control program 397 stored in recording medium 395 is read from recording medium accessing unit 390 by the operation (install process) by control unit 310, and stored in storage unit 350. Specifically, control program 397 is recorded on a medium and the like and distributed as a program product.

Recording medium 395 may be a DVD-ROM (Digital Versatile Disk Read Only Memory), a CD-ROM (Compact Disk Read Only Memory), an MO (Magneto Optical Disk), a floppy (registered trademark) disk, a CF (Compact Flash) card, an SM (Smart Media (registered trademark)), an MMC (Multi Media Card), an SD (Secure Digital) memory card, a memory stick (registered trademark), an xD picture card, an USB memory or any other non-volatile memory.

MFP 300 of the present embodiment is not limited to the configuration shown in FIG. 2. By way of example, temporary data storage 355 and image data storage unit 357 may be one storage circuit that has a configuration capable of storing and retaining data in a non-volatile manner.

A mailer is always active in MFP 300, so that an e-mail can be received and transmitted.

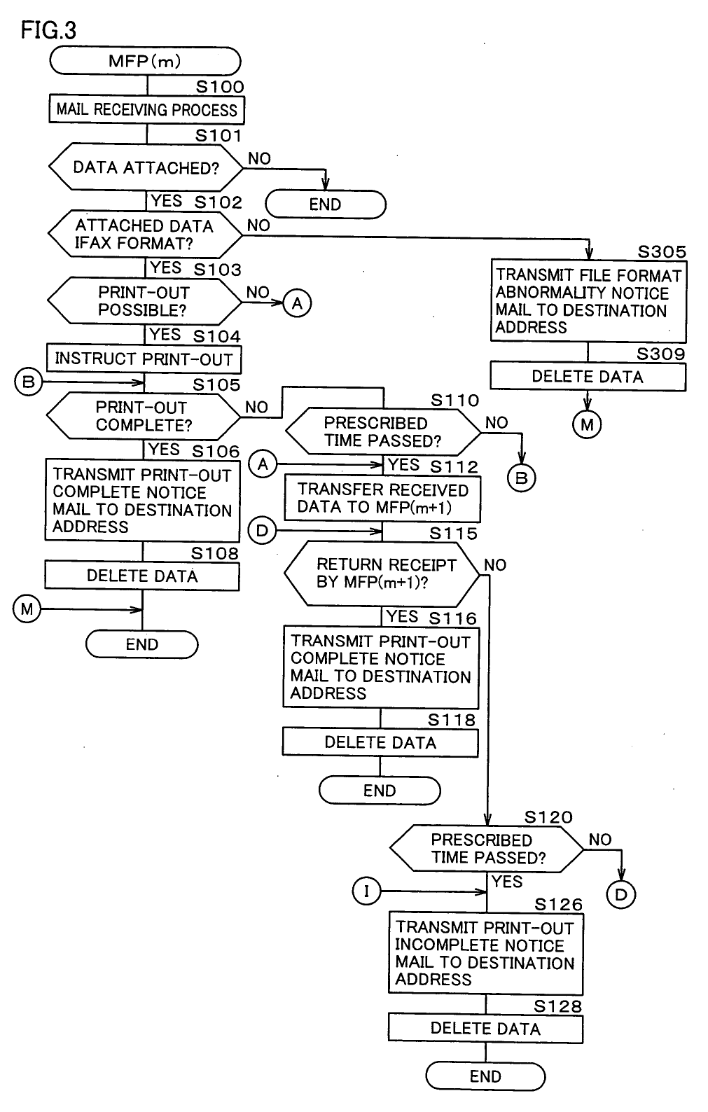

FIG. 3 is a flow chart representing a process executed by an MFP (m). Control unit 310 of MFP (m) performs the process that will be described in the following, in accordance with control program 397 stored in storing unit 350. In the embodiment below, m is assumed to be m=1. Namely, the flow chart of FIG. 3 represents a process performed by MFP(1) (MFP 300.1).

It is assumed that an e-mail to PC 230 is transmitted from PC 120. The e-mail address allotted to PC 230 is “PC_B@mail.co.jp” and the e-mail address allotted to PC 120 is “PC_A@mail.co.jp”.

PC 230 accesses to mail server 160 at a prescribed interval (for example, every 5 minutes), to see if there is an e-mail addressed to PC 230. MFP 300.1 also accesses to mail server 160 at a prescribed interval (for example, every 5 minutes), to see if there is an e-mail addressed to PC 230.

Referring to FIG. 3, in step S100, a mail receiving process is performed. Specifically, control unit 310 accesses to mail server 160 using bus 320, communication unit 330, network circuit 220, communication unit 210 and network 150, in accordance with POP (Post Office Protocol).

Accessing to mail server 160, control unit 310 receives an e-mail utilizing the account data stored in storage unit 350. The received e-mail is addressed to PC 230. Control unit 310 has the data of the received e-mail stored in temporary data storage 355. Then, the flow proceeds to step S101.

In step S101, control unit 310 determines whether the e-mail received in step S100 has an attached data. If it is determined in step S101 that the e-mail received in step S100 has an attached data, the flow proceeds to step S102. If it is determined in step S101 that the e-mail received in step S100 does not have any attached data, the process ends.

In step S102, control unit 310 determines whether or not the attached data is Internet facsimile standard data that is in compliance with the Internet facsimile standard. Specifically, control unit 310 determines whether the attached data is image data of TIFF format and the image data contains a prescribed code indicating that it is the Internet facsimile standard data. The attached data is not necessarily in the TIFF format, and it may be image data of other format.

If it is determined in step S102 that the attached data is the Internet facsimile standard data, the attached data is decoded by control unit 310. Control unit 310 has the decoded data (image data) stored in image data storage unit 357. Thereafter, the flow proceeds to step S103. If it is determined in step S102 that the attached data is not the Internet facsimile standard data, the flow proceeds to step S305, which will be described later.

In step S103, control unit 310 determines whether it is possible to print-out the image data stored in image data storage unit 357 (hereinafter also referred to as output image data) or not. If it is determined in step S103 that it is possible to print-out the output image data, the flow proceeds to step S104. If it is determined in step S103 that print-out of the output image is impossible (for example, because of paper empty or malfunction of printer unit 360), the flow proceeds to step S112, which will be described later.

In step S104, control unit 310 reads the output image data stored in image data storage unit 357 from image data storage unit 357, and instructs printer unit 360 to print-out the output image data (hereinafter also referred to as a print-out instruction).

In response to the print-out instruction from control unit 310, printer unit 360 prints-out the output image data. Then, the flow proceeds to step S105.

In step S105, control unit 310 determines whether printer unit 360 has completed print-out of the output image data or not. If it is determined in step S105 that printer unit 360 has completed print-out of the output image data, the flow proceeds to step S106. If it is determined in step S105 that printer unit 360 has not yet completed print-out of the output image, the flow proceeds to step S110, which will be described later.

In step S106, a print-out complete notice mail notifying that print-out of the output image data has been completed is transmitted to a destination address, that is, PC 230 to which the destination address is allotted. Specifically, control unit 310 reads the internet facsimile data stored in temporary data storage 355, identifies the destination address, and utilizing bus 320, communication unit 330, network circuit 220, communication unit 210 and network 150, transmits the print-out complete notice mail addressed to the destination address to mail server 160. Then, the flow proceeds to step S108.

Mail server 160 receives and temporarily stores the print-out complete notice mail.

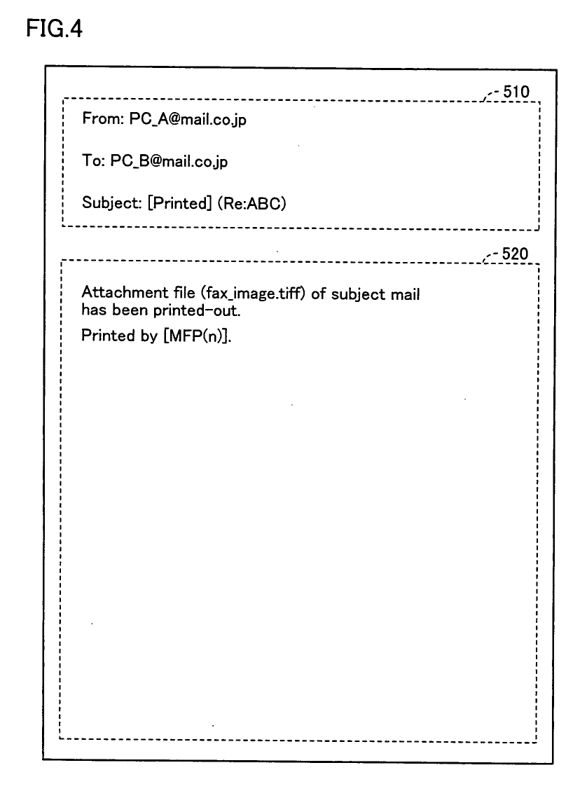

Referring to FIG. 4, the print-out complete notice mail includes a header portion 510 and a text portion 520. In header portion 510, the mail address (PC_@mail.co.jp) allotted to the device that transmitted the Internet facsimile data to PC 230, the mail address (PC_B@mail.co.jp) allotted PC 230 as the destination of the Internet facsimile data, subject and the like are described.

In the “subject”, a message “Printed” is described, notifying that the output image data has been printed-out. Further, the subject (“Re. ABC”) described in the Internet facsimile data (e-mail) received from mail server 160 is also described.

In text portion 520, the fact that the print-out is complete, the name of the attached file that has been printed-out (fax_image.tiff), and the name of the device that printed (MFP(n)) are described.

The print-out complete notice mail shown in FIG. 4 that is temporarily stored in mail server 160 is received by PC 230 when PC 230 accesses to mail server 160.

Therefore, it is possible for PC 230 to know that the output image data based on the Internet facsimile data addressed to itself has been printed-out, and further to know which MFP is used for the print-out.

Again referring to FIG. 3, in step S108, control unit 310 deletes that output image data stored in image data storage unit 357 which has been printed-out. Further, control unit 310 deletes the data of the e-mail to which the image data of TIFF format as the source of the output image data was attached, from temporary data storage 355. Then, the process ends.

If it is determined in step S105 above that printer unit 360 has not yet completed print-out of the output image data, the process of step S110 is performed.

In step S110, control unit 310 determines whether a prescribed time (for example, 60 seconds) has passed from the start of the process of step S100 or not. Specifically, whether the counter value of a time counter monitored by control unit 310 is larger than a prescribed value (for example, 60) or not is determined. The time counter is stored in storage unit 350, and initial value thereof is set to “0”. Under control of control unit 310,the time counter is incremented “1” at every time prescribed period (for example, 1 second) from the start of the process of step S100.

If it is determined in step S110 that the prescribed time period (for example, 60 seconds) has not yet passed from the start of step S100, the process of step S105 is repeated.

If it is determined in step S110 that the prescribed time period (for example, 60 seconds) has passed from the start of step S100, the flow proceeds to step S112.

In step S112, control unit 310 reads the Internet facsimile data received by MFP(1) (MFP 300.1) from temporary data storage 355 and transfers the same to MFP(m+1), that is, MFP(2) (MFP 300.2).

When control unit 310 transfers the Internet facsimile data as an e-mail to MFP(2) (MFP 300.2), it transfers using the IP address allotted to MFP(2) (MFP 300.2). Thereafter, the flow proceeds to step S115.

MFP(m+1), that is, MFP(2) performs the process for receiving the Internet facsimile data as the e-mail.

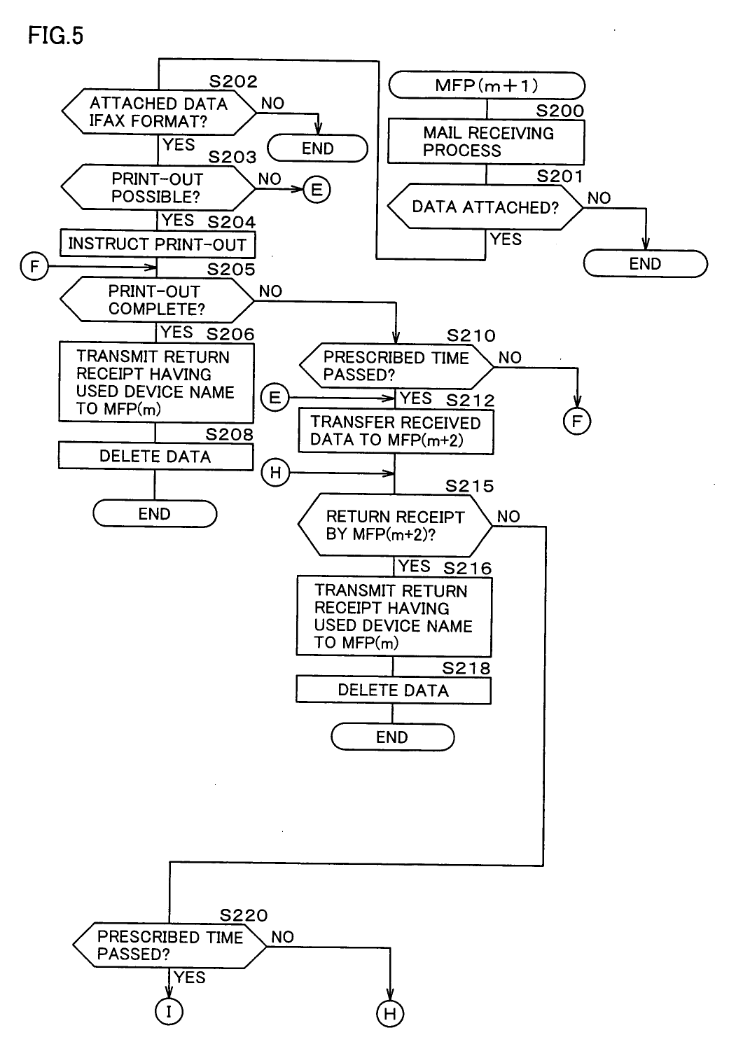

FIG. 5 is a flow chart representing the process executed by MFP(m+1). MFP(m+1) performs the process that will be described in the following, in accordance with the control program 397 stored in storage unit 350. As m=1 here, the flow chart of FIG. 5 represents the process executed by MFP(2) (MFP 300.2).

Referring to FIG. 5, in step S200, a mail receiving process is performed. Under the control of control unit 310, MFP(2) (MFP 300.2) stores the Internet facsimile data as the e-mail received from MFP(1) (MFP 300.1) in temporary data storage 355. Then, the flow proceeds to step S201.

In step S201, control unit 301 determines whether the e-mail received in step S200 has an attached data or not. If it is determined in step S201 that the received e-mail has an attached data, the flow proceeds to step S202. If it is determined in step S201 that the received e-mail does not have any attached data, the process ends.

In step S202, control unit 310 determines whether the attached data is Internet facsimile standard data that is in compliance with the Internet facsimile standard. Specifically, control unit 310 determines whether the attached data is image data of TIFF format and the image data contains a prescribed code indicating that it is the Internet facsimile standard data.

If it is determined in step S202 that the attached data is the Internet facsimile standard data, the attached data is decoded by control unit 310. Control unit 310 has the decoded data (image data) stored in image data storage unit 357. Thereafter, the flow proceeds to step S203. If it is determined in step S202 that the attached data is not the Internet facsimile standard data, the process ends.

In step S203, control unit 310 determines whether it is possible to print-out the image data stored in image data storage unit 357 (output image data) or not. If it is determined in step S203 that it is possible to print-out the output image data, the flow proceeds to step S204. If it is determined in step S203 that print-out of the output image is impossible (for example, because of paper empty or malfunction of printer unit 360), the flow proceeds to step S212, which will be described later.

In step S204, control unit 310 reads the output image data stored in image data storage unit 357 from image data storage unit 357, and instructs printer unit 360 to print-out the output image data.

In response to the print-out instruction from control unit 310, printer unit 360 prints-out the output image data. Then, the flow proceeds to step S205.

In step S205, control unit 310 determines whether printer unit 360 has completed print-out of the output image data or not. If it is determined in step S205 that printer unit 360 has completed print-out of the output image data, the flow proceeds to step S206. If it is determined in step S205 that printer unit 360 has not yet completed print-out of the output image, the flow proceeds to step S210, which will be described later.

In step S206, control unit 310 transmits a print-out complete notice mail notifying that the output image data has been printed-out, as a return receipt, to MFP(m), that is, MFP(1) (MFP 300.1).

Here, the return receipt is an acknowledgement notifying that the mail has been received. In the present embodiment, the return receipt notifies that the output image data based on the received Internet facsimile data has been printed-out.

When control unit 310 transfers the print-out complete notice mail to MFP(1) (MFP 300.1), it transfers using the IP address allotted to MFP(1) (MFP 300.1). In the print-out complete notice mail, the name of the device used for the print out (here, MFP(2)) is described. Thereafter, the process of step S208 is performed.

In step S208, control unit 310 deletes that output image data stored in image data storage unit 357 which has been printed-out. Further, control unit 310 deletes the data of the e-mail to which the image data of TIFF format as the source of the output image data was attached, from temporary data storage 355. Then, the process ends.

Again referring to FIG. 3, in step S115, control unit 310 determines whether the return receipt is received from MFP(m+1), that is, from MFP(2) or not. If it is determined in step S115 that the return receipt is received from MFP(2), the flow proceeds to step S116. If it is determined in step S115 that the return receipt is not received from MFP(2), the flow proceeds to step S120, which will be described later.

In step S116, a print-out complete notice mail, in which the name of the device used for the print-out is described and notifies that print-out of the output image data has been completed, is transmitted to a destination address, that is, PC 230 to which the destination address is allotted, based on the received return receipt.

Specifically, control unit 310 reads the internet facsimile data stored in temporary data storage 355, identifies the destination address, and utilizing bus 320, communication unit 330, network circuit 220, communication unit 210 and network 150, transmits the print-out complete notice mail addressed to the destination address to mail server 160. Then, the flow proceeds to step S118.

Mail server 160 receives and temporarily stores the print-out complete notice mail.

In step S118, control unit 310 deletes that output image data stored in image data storage unit 357 which has been printed-out. Further, control unit 310 deletes the data of the e-mail to which the image data of TIFF format as the source of the output image data was attached, from temporary data storage 355. Then, the process ends.

In step S115 described above, if it is determined that the return receipt is not received from MFP(2), the flow proceeds to step S120.

In step S120, whether a prescribed time (for example, 240 seconds) has passed from the start of the process of step S100 or not is determined. Specifically, whether the counter value of a time counter stored in storage unit 350 is larger than a prescribed value (for example, 240) or not is determined. If it is determined in step S120 that the value of time counter is larger than the prescribed value (for example, 240), the flow proceeds to step S126, which will be described later. If it is determined in step S120 that the value of time counter is not larger than the prescribed value (for example, 240), the process of step S115 is repeated.

In step S120, in place of the process described above, control unit 310 may determine whether the value of a number counter representing the number of repetition of step S115 is larger than a prescribed number (for example, 10) or not. If the value of the number counter is determined to be larger than the prescribed number (for example, 10), the flow proceeds to step S126. If the value of the number counter is determined to be not larger than the prescribed number (for example, 10), control unit 310 adds “1” to the number counter value. The initial value of number counter is set to “0”. Thereafter, the process of step S115 is repeated.

In step S126, a print-out incomplete notice mail notifying that print-out of the output image data has not yet been completed is transmitted to the destination address, that is, PC 230 to which the destination address is allotted.

Specifically, control unit 310 reads the internet facsimile data stored in temporary data storage 355, identifies the destination address, and utilizing bus 320, communication unit 330, network circuit 220, communication unit 210 and network 150, transmits the print-out incomplete notice mail addressed to the destination address to mail server 160. Then, the flow proceeds to step S128.

Mail server 160 receives and temporarily stores the print-out incomplete notice mail.

In step S128, control unit 310 deletes that output image data stored in image data storage unit 357, of which printing has failed. Further, control unit 310 deletes the data of the e-mail to which the image data of TIFF format as the source of the output image data was attached, from temporary data storage 355. Then, the process ends.

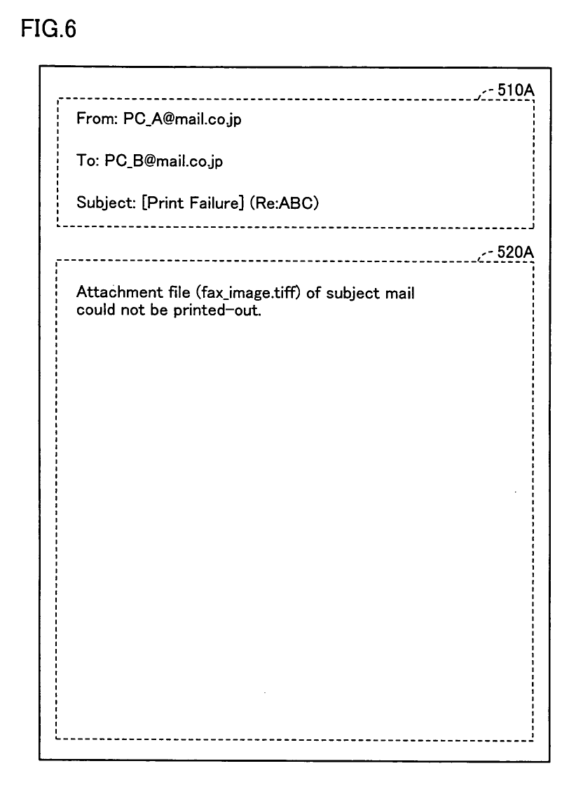

Referring to FIG. 6, the print-out incomplete notice mail includes a header portion 510A and a text portion 520A. In header portion 510A, the mail address (PC_A@mail.co.jp) allotted to the device that transmitted the Internet facsimile data to PC 230, the mail address (PC_B@mail.co.jp) allotted to the PC 230 as the destination of the Internet facsimile data, subject and the like are described.

In the “subject”, a message “Print Failure” is described, notifying that the output image data could not be printed-out. Further, the subject (“Re. ABC”) described in the Internet facsimile data (e-mail) received from mail server 160 is also described.

In text portion 520A, the fact that the print-out failed and the name of the attached file that could not be printed-out (fax_image.tiff) are described.

The print-out incomplete notice mail shown in FIG. 6 that is temporarily stored in mail server 160 is received by PC 230 when PC 230 accesses to mail server 160.

Therefore, it is possible for PC 230 to know that the output image data based on the Internet facsimile data addressed to itself was not printed-out.

If it is determined in step S102 described above that the attached data is not the Internet facsimile standard data, the process of step S305 is performed.

In step S305, a file format abnormality notice mail notifying that the attached data is not the Internet facsimile standard data in compliance with the Internet facsimile standard (that the file type (file format) of the attached data is different) is transmitted to the destination address, that is, PC 230 to which the destination address is allotted.

Specifically, control unit 310 reads the internet facsimile data stored in temporary data storage 355, identifies the destination address, and utilizing bus 320, communication unit 330, network circuit 220, communication unit 210 and network 150, transmits the file format abnormality notice mail addressed to the destination address to mail server 160. Then, the flow proceeds to step S309.

Mail server 160 receives and temporarily stores the file format abnormality notice mail.

In step S309, control unit 310 deletes the data of the e-mail stored in temporary data storage 355. Then, the process ends.

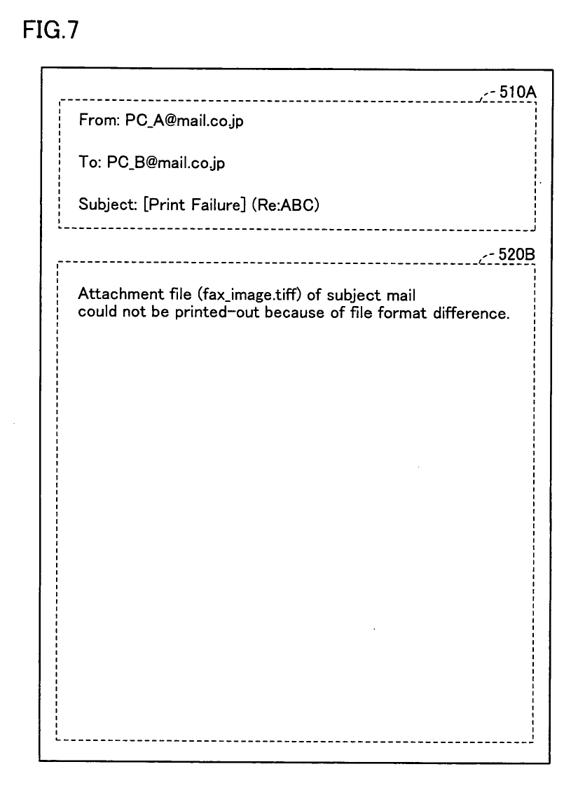

Referring to FIG. 7, file format abnormality notice mail includes a header portion 510A and a text portion 520B. Header portion 510A is the same as header portion 510A of the print-out incomplete notice mail shown in FIG. 6, and therefore, detailed description will not be repeated.

In text portion 520B, the fact that the file format of the attached data is different, that the print-out failed, and the name of the attached file (fax_image.tiff) that could not be printed-out are described.

The file format abnormality notice mail shown in FIG. 7 that is temporarily stored in mail server 160 is received by PC 230 when PC 230 accesses to mail server 160.

Therefore, it is possible for PC 230 to know that the attached data (attached file) attached to the e-mail addressed to itself is not the Internet facsimile standard data in compliance with the Internet facsimile standard, and that the file was not printed-out.

Again referring to FIG. 5, if it is determined in step S205 that the printer unit 360 has not yet completed printing-out of the output image data, the flow proceeds to step S210.

In step S210, whether a prescribed time (for example, 60 seconds) has passed from the start of the process of step S200 or not is determined. Specifically, whether the counter value of a time counter stored in storage unit 350 is larger than a prescribed value (for example, 60) or not is determined. If it is determined in step S210 that the value of time counter is larger than the prescribed value, the flow proceeds to step S212. If it is determined in step S210 that the value of time counter is not larger than the prescribed value, the process of step S205 is repeated.

In step S212, control unit 310 reads the Internet facsimile data received by MFP(2) (MFP 300.2) from temporary data storage 355 and transfers the same to MFP(m+2), that is, MFP(3) (MFP 300.3).

When control unit 310 transfers the Internet facsimile data as an e-mail to MFP(3) (MFP 300.3), it transfers using the IP address allotted to MFP(3) (MFP 300.3). Thereafter, the flow proceeds to step S215.

In MFP(m+2), that is, MFP(3), the process for receiving the Internet facsimile data as the e-mail is performed in the similar manner as in MFP(m+1) described above. Further, in MFP(4) . . . MFP(n), the process for receiving the Internet facsimile data as the e-mail is performed in the similar manner as in MFP(m+1) described above.

In step S215, control unit 310 determines whether an return receipt is received from MFP(m+2), that is, MFP(3) or not. If it is determined in step S215 that a return receipt is received from MFP(3), the flow proceeds to S216. If it is determined in step S215 that a return receipt is not received from MFP(3), the flow proceeds to step S220, which will be described later.

In step S216, based on the received return receipt, control unit 310 transmits a print-out complete notice mail, in which the name of the device used for the print-out is described and notifies that print-out of the output image data has been completed, as a return receipt, to MFP(m), that is, MFP(1) (MFP300.1). Here, in the print-out complete notice mail, the name of the device used for the print-out (in this example, MFP(3)) is described. Then, the flow proceeds to step S218.

In step S218, control unit 310 deletes that output image data stored in image data storage unit 357 which has been printed-out. Further, control unit 310 deletes the data of the e-mail to which the image data of TIFF format as the source of the output image data was attached, from temporary data storage 355. Then, the process ends.

If it is determined in step S215 described above that the return receipt is not received from MFP(3), the flow proceeds to step S220.

In step S220, whether a prescribed time has passed from the start of the process of step S200 or not is determined. Specifically, whether the counter value of a time counter stored in storage unit 350 is larger than a prescribed value or not is determined. If it is determined in step S220 that the value of time counter is larger than the prescribed value, the flow proceeds to step S126 described above. If it is determined in step S220 that the value of time counter is not larger than the prescribed value, the process of step S215 is repeated.

As described above, in the present embodiment, one MFP (MFP 300.1) among a plurality of MFPs 300 receives an e-mail addressed to PC 230 from mail server 160 utilizing the account of PC 230. If the data attached to the received e-mail is the Internet facsimile standard data in compliance with the Internet facsimile standard, MFP 300 prints-out the output image data, and notifies the fact that the data is printed-out to PC 230 by an e-mail.

Therefore, it is possible for the transmitter of the Internet facsimile data to utilize the Internet facsimile by a simple operation of transmitting the Internet facsimile data to the e-mail address allotted to PC 230. Specifically, the transmitter of the Internet facsimile data need not separately use a plurality of e-mail addresses to use the Internet facsimile. As a result, the Internet facsimile can be used with improved convenience.

Further, it is possible for a receiver of the Internet facsimile data to utilize the Internet facsimile in a simple manner, without the necessity of allocating MFP dedicated mail addresses to multifunction peripherals (MFPs). As a result, the Internet facsimile can be used with improved convenience.

Further, as a plurality of MFPs are used that can transmit/receive Internet facsimile data, the output image data based on the Internet facsimile data can be printed-out with higher reliability.

In the present embodiment, if the MFP that received the Internet facsimile data is not capable of printing-out, the received Internet facsimile data is transmitted to another MFP. The present invention, however, is not limited thereto. By way of example, the Internet facsimile data may be transmitted simultaneously to a plurality of MFPs, other than the MFP that received the Internet facsimile data, connected to one same network.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image forming apparatus, comprising:
a storage unit storing an account data related to a prescribed destination;
a communication unit transmitting/receiving an e-mail;
a control unit determining whether data attached to said e-mail is an image data of a prescribed format or not; and
a printer unit printing an image in accordance with the image data; wherein said communication unit receives a first e-mail corresponding to said destination utilizing said account data; and
said control unit determines whether data attached to said first e-mail is an image data of a prescribed format or not and if said attached data is image data of said prescribed format, controls said printer unit such that the image in accordance with the image data is printed, and controls said communication unit such that a second e-mail notifying completion of the print is transmitted to the destination of said first e-mail.

2. The-image forming apparatus according to claim 1, wherein
said control unit determines whether said printer unit can print the image in accordance with said image data or not, and if it is determined that printing is impossible, controls said communication unit such that the first e-mail is transferred to another image forming apparatus.

3. The image forming apparatus according to claim 2, wherein
said communication unit receives from said another image forming apparatus a print complete notice notifying that the image has been printed in accordance with the data attached to said transferred first e-mail; and
when said communication unit receives said print complete notice from said another image forming apparatus, said control unit controls said communication unit such that a third e-mail containing information specifying said another image forming apparatus and notifying the completion of printing is transmitted to the destination of said first e-mail.

4. The image forming apparatus according to claim 3, wherein
said control unit determines whether an image could be printed based on said image data by said another image forming apparatus or not, and if it is determined that printing failed, controls said communication unit such that said first e-mail is transmitted to an image forming apparatus different from said another image forming apparatus.

5. A program product causing a computer controlling an image forming apparatus including a storage unit storing account data related to a prescribed destination and a printer unit for printing data, to execute a print notifying function, causing said computer to execute the steps of:
receiving a first e-mail corresponding to said destination, utilizing said account data;
determining whether the data attached to said first e-mail is image data of a prescribed format or not;
if said attached data is image data of said prescribed format, controlling said printer unit such that an image based on the image data is printed; and
transmitting a second e-mail notifying completion of printing to said destination of the first e-mail.

6. The program product according to claim 5, causing said computer to further execute the steps of:
determining whether said printer unit is capable of printing the image based on said image data; and
if it is determined that said printer unit is not capable of printing said image, transferring said first e-mail to another image forming apparatus.

7. The program product according to claim 6, causing said computer to further execute the steps of:
receiving from said another image forming apparatus a print complete notice notifying that the image has been printed based on the data attached to said transferred first e-mail; and
when said print complete notice is received from said another image forming apparatus, transmitting a third e-mail containing information specifying said another image forming apparatus and notifying the completion of printing to the destination of said first e-mail.

8. The program product according to claim 7, causing the computer to further execute the steps of:
determining whether said another image forming apparatus could print the image based on the image data; and
if it is determined that said another image forming apparatus could not print the image, transferring said first e-mail to an image forming apparatus different from said another image forming apparatus.
